(19) United States
(12) Patent Application Publication
(10) Pub. No.: US 2026/0366106 A1
(43) Pub. Date: Nov. 19, 2026

(54) MAGNETIC STEEL CONTAINING HIGH-ABUNDANCE RARE EARTH ELEMENTS, PREPARATION METHOD THEREFOR, AND USE THEREOF

(71) Applicant: FUJIAN GOLDEN DRAGON RARE-EARTH Co., Ltd., Longyan, Fujian (CN)

(72) Inventors: Jinlei WANG, Longyan (CN); Shicong LIAO, Longyan (CN); Jiaying HUANG, Longyan (CN); Gang FU, Longyan (CN)

(21) Appl. No.: 19/121,820

(22) PCT Filed: Apr. 23, 2023
(86) PCT No.: PCT/CN2023/090162

§ 371 Date: Apr. 17, 2025

(30) Foreign Application Priority Data
Nov. 30, 2022 (CN) 202211543719.0

(51) Int. Cl. C22C 33/02; B22F 3/16; B22F 3/24; B22F 9/02; B22F 9/04; C22C 33/04; C22C 38/00; C22C 38/06; C22C 38/14; C22C 38/16; H01F 1/057

(52) U.S. Cl. CPC C22C 33/0207; B22F 3/16; B22F 9/023; B22F 9/04; C22C 33/0278; C22C 33/04; C22C 38/002; C22C 38/005; C22C 38/06; C22C 38/14; C22C 38/16; H01F 1/0571; B22F 2003/242; B22F 2003/248; B22F 2009/041; B22F 2009/044; B22F 2201/02; B22F 2201/11; B22F 2202/05; B22F 2301/355; B22F 2998/10; B22F 2999/00; C22C 2202/02

(57) ABSTRACT

The disclosure discloses a magnetic steel containing high-abundance rare earth elements, the preparation method therefor and use thereof. The preparation method for a magnetic steel containing high-abundance rare earth elements comprises the following steps of: (1) subjecting a powder of a main alloy and a powder of an auxiliary alloy to mixing, pulverizing, shaping and sintering, wherein the main alloy has a composition of (REₐPr_{b}Nd_{c})_{d}Fe_{c}Al_{f}Cu_{g}GaₕZrᵢTiⱼBₖ; RE is a high-abundance rare earth element comprising one or more of La, Ce, Y, Er, Yb, Gd, Tm and Sm; the auxiliary alloy has a composition of RₘFeₙCuₒAlₚ; R is a rare earth element; (2) subjecting a sintered body obtained in step (1) and a diffusion source raw material composition to grain boundary diffusion treatment. The present disclosure improves the magnetic properties of a magnet containing high-abundance rare earth by constructing a composite magnetic hardening shell layer.

### CROSS-REFERENCE TO RELATED APPLICATIONS

This application is a U.S. National Stage Application under 35 U.S.C. 371 of PCT International Application No. PCT/CN2023/090162, filed on April 23,2023, which claims priority to Chinese Patent Application No. 202211543719.0 filed on Nov. 30, 2022, which are incorporated herein by reference in their entireties.

### FIELD OF THE INVENTION

The disclosure relates to a magnetic steel containing high-abundance rare earth elements, the preparation method therefor and use thereof.

### BACKGROUND OF THE INVENTION

Neodymium-iron-boron permanent magnet materials are widely used in electronic products, automobiles, wind power, home appliances, elevators and industrial robots due to their excellent magnetic properties. For example, they provide magnetic fields in permanent magnet motors such as focusing motors, drive motors, wind turbines, elevator traction machines, and positioning motors. The demand for neodymium-iron-boron permanent magnet materials is increasing, among which the demand for Pr/Nd/Dy/Tb is increasing significantly. At the same time, high-abundance rare earths and other rare earths are largely shelved, resulting in waste.

However, adding high-abundance rare earth elements such as La, Ce, Y, Er, Yb, Gd, Tm or Sm to neodymium-iron-boron permanent magnet materials will reduce the magnetic properties of the permanent magnet materials, which limits the application of high-abundance rare earth elements such as La, Ce, Y, Er, Yb, Gd, Tm or Sm in permanent magnet materials.

### SUMMARY OF THE INVENTION

Mainly to overcome the defect in the prior art that the use of high-abundance rare earth elements cannot effectively improve the coercive force and maintain the remanence, the present disclosure provides a magnetic steel containing high-abundance rare earth elements, the preparation method therefor and use thereof. The present disclosure makes full use of the HA of Y/Er/Yb/Gd/Tm/Sm, Pr/Nd/Ho/Dy, and Dy/Tb by constructing a composite magnetic hardening shell layer, thereby improving the magnetic properties of magnets containing high-abundance rare earths.

The present disclosure solves the above technical problems mainly through the following technical solutions.

A first technical solution of the disclosure provides a preparation method for a magnetic steel containing high-abundance rare earth elements, comprising following steps of.
(1) subjecting a powder of a main alloy and a powder of an auxiliary alloy to mixing, pulverizing, shaping and sintering,
wherein the main alloy has a composition of (REₐPr_{b}Nd_{c})_{d}FeₑAl_{f}Cu_{g}GaₕZrᵢTiⱼBₖ;
RE is a high-abundance rare earth element; RE comprises one or more of La, Ce, Y, Er, Yb, Gd, Tm and Sm;
in terms of atomic percentage, a is 0.05-0.3; b is 0.1-1.2; c is 0.5-0.9; d is 13-15; e is 78-80; f is 0.2-0.4; g is 0.1-0.3; h is 0.2-0.5; i is 0.2-0.4; j is 0.2-0.4; k is 5-6;
wherein the auxiliary alloy has a composition of RₘFeₙCuₒAlₚ;
R is a rare earth element;
in terms of atomic percentage, m is 45-55; n is 35-45; o is 4-8; p is 4-8;
(2) subjecting a sintered body obtained in step (1) and a diffusion source raw material composition to grain boundary diffusion treatment;
wherein, in terms of atomic percentage, the diffusion source raw material composition comprises a heavy rare earth element with a content of more than m.

In the present disclosure, in the composition of the main alloy, RE preferably comprises Y In the present disclosure, preferably, in the composition of the main alloy, a is 0.1 in atomic percentage.

In the present disclosure, preferably, in the composition of the main alloy, b is 0.18-1 in atomic percentage, more preferably 0.22-0.9.

In the present disclosure, preferably, in the composition of the main alloy, c is 0.55-0.8 in atomic percentage, more preferably 0.57-0.68.

In the present disclosure, preferably, in the composition of the main alloy, d is 13-14 in atomic percentage, more preferably 13.64.

In the present disclosure, preferably, in the composition of the main alloy, in terms of atomic percentage: e is 78.5-80, more preferably 78.88-79.48, for example 79.26.

In the present disclosure, preferably, in the composition of the main alloy, in terms of atomic percentage: f is 0.2-0.3, more preferably 0.24.

In the present disclosure, preferably, in the composition of the main alloy, in terms of atomic percentage: g is 0.2.

In the present disclosure, preferably, in the composition of the main alloy, in terms of atomic percentage: h is 0.3-0.4, more preferably 0.36.

In the present disclosure, preferably, in the composition of the main alloy, in terms of atomic percentage: i is 0.2-0.3, more preferably 0.26.

In the present disclosure, preferably, in the composition of the main alloy, in terms of atomic percentage: j is 0.2-0.3, more preferably 0.27.

In the present disclosure, preferably, in the composition of the main alloy, in terms of atomic percentage: k is 5.5-6, more preferably 5.75.

In the present disclosure, preferably, the main alloy has a composition of:

(Y_{0.1}PrNd_{0.9})_{13.64}Fe_{79.26}Al_{0.24}Cu_{0.2}Ga_{0.36}Zr_{0.26}Ti_{0.27}B_{5.75}; or

(Y_{0.05}Pr_{0.15}Nd_{0.57})_{13.64}Fe_{78.88}Al_{0.24}Cu_{0.2}Ga_{0.36}Zr_{0.26}Ti_{0.27}B_{5.75}; or

(La_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or

(Ce_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or

(Yb_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or

(Tm_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or

(Gd_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or

(Sm_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}.

In the present disclosure, the main alloy can be used to form the main phase center and the main phase outer layer.

In the present disclosure, preferably, in the composition of the auxiliary alloy, R is Dy or Pr.

In the present disclosure, preferably, in the composition of the auxiliary alloy, in atomic percentage: m is 50; n is 40; o is 5; p is 5.

In the present disclosure, preferably, the composition of the auxiliary alloy is Dy₅₀Fe₄₀Cu₅Al₅ or Pr₅₀Fe₄₀Cu₅Al₅.

In the present disclosure, in step (1), the mass ratio of the powder of the main alloy to the powder of the auxiliary alloy is preferably (90-99):(10-1), more preferably 98:2.

In the present disclosure, in step (1), preferably, the pulverization process comprises hydrogen decrepitation pulverization and micro-pulverization.

Here, the hydrogen decrepitation pulverization preferably comprises hydrogen absorption, dehydrogenation, and cooling treatment.

Here, the micro-pulverization is preferably jet-milling pulverization.

The jet-milling pulverization is preferably carried out in anitrogen atmosphere having an oxidizing gas with a content of 150 ppm or less.

The pulverization chamber pressure of the jet-milling pulverization is preferably 0.38 MPa.

The jet-milling pulverization time of the jet-milling pulverization is preferably 3 hours.

In the present disclosure, in step (1), preferably, the shaping process is a magnetic field shaping method or a hot pressing and hot deforming method.

Here, the magnetic field strength of the magnetic field shaping method is preferably 1.5 T or more, for example, 1.6 T.

In the present disclosure, in step (1), preferably, the sintering process comprises preheating, sintering, and cooling under vacuum conditions.

Here, the preheating temperature is preferably 300-600 °C. The preheating time is preferably 1-2h. More preferably, the preheating is performed at 300 °C and 600 °C for 1 h respectively.

Here, the sintering temperature is preferably 1080-1090 °C.

Here, the sintering time is preferably 4h.

In the present disclosure, in step (2), preferably, the diffusion source raw material composition is an alloy powder containing a heavy rare earth element; it can be used to form a main phase epitaxial layer.

Here, the heavy rare earth element preferably comprises Dy and/or Tb.

The atomic percentage of the heavy rare earth element is preferably 50-80 at %; more preferably 60-70 at %.

In the present disclosure, in step (2), preferably, the diffusion source raw material composition further comprises M; the M preferably comprises one or more of Al, Cu and Ga; more preferably Al and Cu.

Here, the atomic percentage of M is preferably 20-50 at %; more preferably 30-40 at %; When the M comprises Cu, the atomic percentage of Cu is preferably 10-25 at %; more preferably 15-20 at %.

When the M comprises Al, the atomic percentage of Al is preferably 10-25 at %; more preferably 15-20 at %.

In the present disclosure, in step (2), preferably, the diffusion source raw material composition is Dy₇₀Cu₁₅Al₁₅.

In the present disclosure, the mass ratio of the sintered body obtained in step (1) to the diffusion source raw material composition is (98-99.5):(0.5-2), preferably 99.2:0.8.

In the present disclosure, in step (2), preferably, the grain boundary diffusion is carried out in a high-purity Ar gas atmosphere. The pressure of the high-purity Ar gas atmosphere is preferably 8×10⁻³ Pa⁻²×10⁵ Pa.

In the present disclosure, in step (2), preferably, the temperature of the grain boundary diffusion is 800-980 °C, for example, 900 °C.

In the present disclosure, in step (2), preferably, in the grain boundary diffusion, the time of the grain boundary diffusion is 12-30 h, preferably 15-28 h; for example, 24h.

In the present disclosure, in step (2), preferably, after the grain boundary diffusion, diffusion heat treatment and/or aging heat treatment are also comprised.

Here, the temperature of the diffusion heat treatment is preferably 850-950 °C, for example, 900 °C. The time of the aging heat treatment is preferably 20-40 h, for example, 24h.

Here, the temperature of the aging heat treatment is preferably 440-580 °C, for example, 500 °C. The time of the aging heat treatment is preferably 2-4 h, for example, 4h.

In the present disclosure, the powder of the main alloy is preferably prepared by the following method: the RE, the Pr, the Nd, the Fe, the Al, the Cu, the Ga, the Zr, the Ti and the B are mixed in proportion, and then smelted and cast.

Here, the smelting is preferably carried out in a high-frequency vacuum induction smelting furnace. The vacuum degree of the smelting is preferably 5×10⁻² Pa. The smelting temperature is preferably 1500 °C or less.

Here, the casting is preferably carried out in an Ar gas atmosphere, and cooled at a rate of 10² °C/sec-10⁴ °C/sec.

In the present disclosure, the powder of the auxiliary alloy is preferably prepared by the following method: the R, the Fe, the Cu and the Al are mixed in proportion, and heated and smelted in a vacuum induction smelting furnace under argon protection at a rate of 10² °C/sec-10⁴ °C/sec.

A second technical solution of the disclosure provides a magnetic steel containing high-abundance rare earth elements, which is prepared by the preparation method for the magnetic steel containing high-abundance rare earth elements as described above.

A third technical solution of the disclosure provides a magnetic steel containing high-abundance rare earth elements, wherein a main phase of the magnetic steel containing high-abundance rare earth elements comprises a main phase center, a main phase outer layer and a main phase epitaxial layer; the main phase outer layer is located on an outer side of the main phase center and completely covers the main phase center; the main phase epitaxial layer is located on an outer side of the main phase outer layer and completely covers the main phase outer layer;
wherein a content of a high-abundance rare earth element RE₁ in the main phase center is A₁ at %, wherein at % refers to an atomic percentage of the high-abundance rare earth element in the main phase center in the magnetic steel containing high-abundance rare earth elements;
a content of a high-abundance rare earth element RE₂ in the main phase outer layer is A₂ at %, wherein at % refers to an atomic percentage of the high-abundance rare earth element in the main phase outer layer in the magnetic steel containing high-abundance rare earth elements;
A₁ at %>A₂ at %;
wherein the main phase center has an average diameter of r₁, and the main phase outer layer has an average thickness of r₂, 1<r₁/r₂<5;
wherein the main phase epitaxial layer comprises a heavy rare earth element RH; and the main phase epitaxial layer has an average thickness of r₃, 2 nm<r₃<500 nm.

In the present disclosure, the main phase center may comprise a light rare earth element RL₁, and the light rare earth element RL₁ comprises a high-abundance rare earth element RE₁.

In the main phase center, the light rare earth element RL₁ preferably comprises Pr and/or Nd. The atomic percentage of the light rare earth element RL₁ is preferably 9.0 at %-10.0 at %, for example, 9.63 at %.

In the main phase center, the atomic percentage of the high-abundance rare earth element RE₁ is preferably 0.5 at %-3.0 at %, more preferably 2.0 at %-3.0 at %, for example 2.69 at %.

In the present disclosure, the main phase outer layer may comprise a light rare earth element RL₂, and the light rare earth element RL₂ comprises a high-abundance rare earth element RE₂.

In the main phase outer layer, the light rare earth element RL₂ preferably comprises Pr and/or Nd. The atomic percentage of the light rare earth element RL₂ is preferably 9.0 at %-10.0 at %, such as 9.91 at %.

In the present disclosure, the high-abundance rare earth element RE₁ in the main phase center and the high-abundance rare earth element RE₂ in the main phase outer layer can independently comprise one or more of La, Ce, Y, Er, Yb, Gd, Tm and Sm; preferably comprise Y, Yb, Gd, Tm or Sm.

In the present disclosure, the atomic percentage of the high-abundance rare earth element RE₂ in the main phase outer layer is preferably 0.5 at %-3.0 at %, more preferably 2.0 at %-3.0 at %, for example 2.28 at %.

In the present disclosure, the average diameter of the main phase is R, preferably, 2 μm<R<15 μm.

In the present disclosure, the average diameter of the main phase center is r₁, the average thickness of the main phase outer layer is r₂, and r1/r2 is preferably 2-4, for example, 3.

In the present disclosure, the average thickness of the main phase epitaxial layer is r₃, and r₃ is preferably 100-400 nm, for example, 200-300 nm.

In the main phase epitaxial layer, the heavy rare earth element RH preferably comprises Dy and/or Tb.

In the main phase epitaxial layer, the content of the heavy rare earth element RH is preferably 2.5 wt %; the percentage refers to the mass percentage of the heavy rare earth element RH in the magnetic steel containing high-abundance rare earth elements.

In the present disclosure, the magnetic steel containing high-abundance rare earth elements generally further comprises a grain boundary phase. The grain boundary phase can be conventional in the art. Preferably, the grain boundary phase comprises elements such as Fe, Al, Cu, Ga, Zr, Ti, and B.

In the present disclosure, the anisotropy fields of the main phase epitaxial layer, the main phase center and the main phase outer layer decrease in sequence.

A fourth technical solution of the disclosure provides use of the magnetic steel containing high-abundance rare earth elements described above as an electronic component in an electric motor.

On the basis of conforming to the common sense in the art, the above-mentioned preferred conditions can be arbitrarily combined to obtain the preferred embodiments of the present disclosure.

The reagents and raw materials used in the present disclosure are commercially available.

The positive and progressive effects of the present disclosure are as follows: In the magnetic steel containing high-abundance rare earth elements according to the present disclosure, the content of high-abundance rare earth elements in the main phase center can be higher than that in the main phase outer layer, and the magnetic properties of the magnetic steel are better. In addition, regarding the magnetic steel containing high-abundance rare earth elements according to the present disclosure, the main phase outer layer and the main phase epitaxial layer in the main phase can form a composite magnetic hardening shell layer, which is beneficial to improving the magnetic properties of the magnetic steel and improving the utilization rate of the heavy rare earth elements.

According to micromagnetism theory, the impurities or defects on the surface of the grains make the surface of the grains more easily demagnetized, thereby causing the overall demagnetization of the grains. The area closer to the surface of the grains is more easily demagnetized. In order to enhance the anti-demagnetization ability and improve the coercive force of the magnet, the area on the surface of the grain needs to be magnetically strengthened. Regarding the magnetic steel containing high-abundance rare earth elements according to the present disclosure, the anti-demagnetization ability of the main phase grains gradually weakens from the center to the surface. However, since it has a composite magnetic hardening shell layer with gradually increasing magnetic hardening strength in the main phase grain center, the outer layer, and the epitaxial layer, it can improve the anti-demagnetization ability of the grains while maintaining cost optimization.

### BRIEF DESCRIPTION OF THE DRAWINGS

FIG. 1 is a schematic diagram of the main phase structure of the magnetic steel containing high-abundance rare earth elements in Examples 1-10.

### DETAILED DESCRIPTION OF THE INVENTION

The present disclosure is further described below by way of examples, but the present disclosure is not limited to the scope of the examples. The experimental methods in the following examples without specifying specific conditions are carried out according to conventional methods and conditions, or selected according to the product specifications.

### Example 1

The preparation method for the Y-containing magnetic steel in Example 1 is as follows:

The general chemical formula of the main phase raw material for the Y-containing permanent magnet is: (Y_{0.1}PrNd_{0.9})_{13.64}Fe_{79.26}Al_{0.24}Cu_{0.2}Ga_{0.36}Zr_{0.26}Ti_{0.27}B_{5.75}.

The prepared raw materials were placed in a crucible made of alumina, and vacuum smelted in a high-frequency vacuum induction smelting furnace at a temperature of 1500 °C or less in a vacuum of 5×10⁻² Pa. After vacuum melting, Ar gas was introduced into the smelting furnace to make the gas pressure reach 55,000 Pa, and then casting was performed to obtain a rapidly cooled main phase alloy at a cooling rate of 10² °C/second to 10⁴ °C/second.

The composition of the grain boundary auxiliary alloy is Dy₅₀Fe₄₀Cu₅Al₅ (at %). According to the composition of the grain boundary alloy, the required raw materials were prepared, heated and smelted in a vacuum medium frequency induction smelting furnace under argon protection, and a rapidly cooled grain boundary auxiliary phase alloy was obtained at a cooling rate of 10² °C/s to 10⁴ °C/s.

The main phase alloy and the grain boundary auxiliary phase alloy were mixed evenly at a mass ratio of 98:2.

Hydrogen decrepitation pulverization process: The uniformly mixed alloys were plased into a hydrogen decrepitation furnace. Then, hydrogen with a purity of 99.9% was introduced into the hydrogen decrepitation furnace, and the hydrogen pressure was maintained at 0.15 MPa. After sufficient hydrogen absorption, the temperature was raised while vacuuming, and the hydrogen was fully dehydrogenated. After cooling, the powder after hydrogen decrepitation pulverization was removed.

Micro-pulverization process: In a nitrogen atmosphere having an oxidizing gas with a content of 150 ppm or less, the powder after hydrogen decrepitation pulverization was subjected to a jet-milling pulverization for 3 hours under a pulverization chamber pressure of 0.38 MPa to obtain a fine powder. Oxidizing gas refers to oxygen or moisture.

Zinc stearate was added to the powder after the jet-milling pulverization. The amount of zinc stearate added was 0.12% of the weight of the mixed powder. Then a V-type mixer was used for thorough mixing.

Magnetic field shaping process: By using a right-angle oriented magnetic field shaping machine, the above-mentioned powder with zinc stearate added was subjected to primary shaping to be shaped into a cube with a side length of 25 mm at a forming pressure of 0.35 ton/cm² in an orienting magnetic field of 1.6 T. After the primary shaping, demagnetization was performed in a magnetic field of 0.2 T. In order to prevent the molded body from contacting the air after the primary shaping, the molded body was sealed and then a secondary forming machine (an isostatic pressing machine) was used for secondary forming at a pressure of 1.3 ton/cm².

Sintering process: Each molded body was moved into a sintering furnace for sintering. Sintering was carried out under a vacuum of 5×10−3 Pa, at 300 °C and 600 °C for 1 hour each. Then, sintering was carried out at a temperature of 1080 °C for 4 hours. After that, Ar gas was introduced to make the gas pressure reached 0.1 MPa, and then cooled to room temperature.

After a sintered body was prepared, it was further subjected to grain boundary diffusion. The sintered body was processed into a magnet with a diameter of 20 mm and a sheet thickness of less than 7 mm, wherein the thickness direction is the magnetic field orientation direction. After the surface was cleaned, an alloy powder (Dy₇₀Cu₁₅Al₁₅) made of a Dy alloy was fully sprayed on the magnet. The coated magnet was dried. In a high-purity Ar gas atmosphere, the alloy powder with Dy elements attached to the magnet surface was subjected to diffusion heat treatment at 900 °C for 24 hours. Then, the temperature was lowered to room temperature. The diffused magnet was subjected to aging heat treatment, wherein the heat treatment temperature was 500 °C and the heat treatment time was 4 hours.

### Example 2

The preparation method for the Y-containing magnetic steel in Example 2 is as follows:

The general chemical formula of the main phase raw material for the Y-containing permanent magnet is: (Y_{0.1}PrNd_{0.9})_{13.64}Fe_{79.26}Al_{0.24}Cu_{0.2}Ga_{0.36}Zr_{0.26}Ti_{0.27}B_{5.75}.

The prepared raw materials were placed in a crucible made of alumina, and vacuum smelted in a high-frequency vacuum induction smelting furnace at a temperature of 1500 °C or less in a vacuum of 5×10⁻² Pa. After vacuum melting, Ar gas was introduced into the smelting furnace to make the gas pressure reach 55,000 Pa, and then casting was performed to obtain a rapidly cooled main phase alloy at a cooling rate of 10² °C/second to 10⁴ °C/second.

The composition of the grain boundary auxiliary alloy is Pr₅₀Fe₄₀Cu₅Al₅ (at %). According to the composition of the grain boundary alloy, the required raw materials were prepared, heated and smelted in a vacuum medium frequency induction smelting furnace under argon protection, and a rapidly cooled grain boundary auxiliary phase alloy was obtained at a cooling rate of 10² °C/s to 10⁴ °C/s.

The main phase alloy and the grain boundary auxiliary phase alloy were mixed evenly at a mass ratio of 98:2.

Hydrogen decrepitation pulverization process: The uniformly mixed alloys were plased into a hydrogen decrepitation furnace. Then, hydrogen with a purity of 99.9% was introduced into the hydrogen decrepitation furnace, and the hydrogen pressure was maintained at 0.15 MPa. After sufficient hydrogen absorption, the temperature was raised while vacuuming, and the hydrogen was fully dehydrogenated. After cooling, the powder after hydrogen decrepitation pulverization was removed.

Micro-pulverization process: In a nitrogen atmosphere having an oxidizing gas with a content of 150 ppm or less, the powder after hydrogen decrepitation pulverization was subjected to a jet-milling pulverization for 3 hours under a pulverization chamber pressure of 0.38 MPa to obtain a fine powder. Oxidizing gas refers to oxygen or moisture.

Zinc stearate was added to the powder after the jet-milling pulverization. The amount of zinc stearate added was 0.12% of the weight of the mixed powder. Then a V-type mixer was used for thorough mixing.

Magnetic field shaping process: By using a right-angle oriented magnetic field shaping machine, the above-mentioned powder with zinc stearate added was subjected to primary shaping to be shaped into a cube with a side length of 25 mm at a forming pressure of 0.35 ton/cm² in an orienting magnetic field of 1.6 T. After the primary shaping, demagnetization was performed in a magnetic field of 0.2 T. In order to prevent the molded body from contacting the air after the primary shaping, the molded body was sealed and then a secondary forming machine (an isostatic pressing machine) was used for secondary forming at a pressure of 1.3 ton/cm².

Sintering process: Each molded body was moved into a sintering furnace for sintering. Sintering was carried out under a vacuum of 5×10⁻³ Pa, at 300 °C and 600 °C for 1 hour each. Then, sintering was carried out at a temperature of 1080 °C for 4 hours. After that, Ar gas was introduced to make the gas pressure reached 0.1 MPa, and then cooled to room temperature.

After a sintered body was prepared, it was further subjected to grain boundary diffusion. The sintered body was processed into a magnet with a diameter of 20 mm and a sheet thickness of less than 7 mm, wherein the thickness direction is the magnetic field orientation direction. After the surface was cleaned, an alloy powder (Dy₇₀Cu₁₅Al₁₅) made of a Dy alloy was fully sprayed on the magnet. The coated magnet was dried. In a high-purity Ar gas atmosphere, the alloy powder with Dy elements attached to the magnet surface was subjected to diffusion heat treatment at 900 °C for 24 hours. Then, the temperature was lowered to room temperature. The diffused magnet was subjected to aging heat treatment, wherein the heat treatment temperature was 500 °C and the heat treatment time was 4 hours.

### Example 3

The sintered body raw material composition for the Y-containing magnetic steel in Example 3 is as follows in terms of atomic percentage:
(Y_{0.05}Pr_{0.18}Nd_{0.57})_{13.64}Fe_{78.88}Al_{0.24}Cu_{0.2}Ga_{0.36}Zr_{0.26}Ti_{0.27}B_{5.75};
Other details are the same as those in Example 1.

### Example 4

The sintered body raw material composition for the La-containing magnetic steel in Example 4 is as follows in terms of atomic percentage:

(La_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
Other details are the same as those in Example 1.

### Example 5

The sintered body raw material composition for the Ce-containing magnetic steel in Example 5 is as follows in terms of atomic percentage:

(Ce_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
Other details are the same as those in Example 1.

### Example 6

The sintered body raw material composition for the Yb-containing magnetic steel in Example 6 is as follows in terms of atomic percentage:

(Yb_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
Other details are the same as those in Example 1.

### Example 7

The sintered body raw material composition for the Tm-containing magnetic steel in Example 7 is as follows in terms of atomic percentage:

(Tm_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
Other details are the same as those in Example 1.

### Example 8

The sintered body raw material composition for the Gd-containing magnetic steel in Example 8 is as follows in terms of atomic percentage:

(Gd_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
Other details are the same as those in Example 1.

### Example 9

The sintered body raw material composition for the Sm-containing magnetic steel in Example 9 is as follows in terms of atomic percentage:

(Sm_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
Other details are the same as those in Example 1.

### Example 10

The sintered body raw material composition for the Er-containing magnetic steel in Example 10 is as follows in terms of atomic percentage:

(Er_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
Other details are the same as those in Example 1.

### Comparative Example 1

In Comparative Example 1, the sintered body raw material composition of the Y-containing magnetic steel is: (Y_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}, and the diffusion source raw material composition used was Dy₃₀Fe₄₀Cu₁₅Al₁₅ in atomic percentage;
Other details are the same as those in Example 1.

### Comparative Example 2

In Comparative Example 2, the sintered body raw material composition of the Y-containing magnetic steel is: (Y_{0.4}Pr_{0.18}Nd_{0.57})_{13.64}Fe_{79.48}Al_{0.24}Cu_{0.2}Ga_{0.36}Zr_{0.26}Ti_{0.27}B_{5.75} in atomic percentage;
Other details are the same as those in Example 1.

### Comparative Example 3

In Comparative Example 3, the sintered body raw material composition of the Y-containing magnetic steel is: (Y_{0.1}Pr_{0.22}Nd_{0.68})_{13.64}Fe_{79.48}Al_{0.24}Cu_{0.2}Ga_{0.36}Zr_{0.26}Ti_{0.27}B_{5.75} in atomic percentage; and the temperature of the diffusion heat treatment was 800 °C.
Other details are the same as those in Example 1.

### Effect Example 1

### 1. Characterization of Microstructure

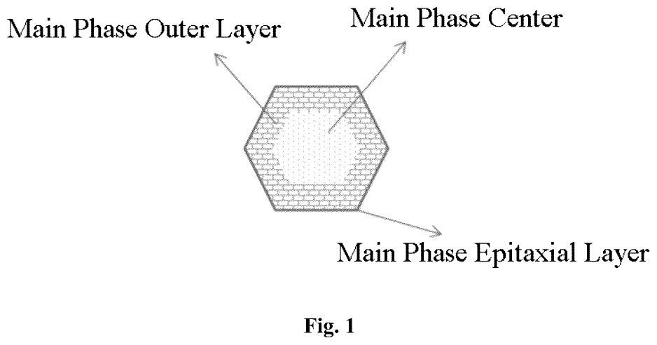

(1) The structural schematic diagram of the main phase in the magnetic steels containing high abundance rare earth elements of Examples 1-10 is shown in FIG. 1.
(2) The magnetic steels containing high-abundance rare earth elements in Example 1-2 was tested by using a field emission electron probe microanalyzer EPMA surface distribution test.

According to the results of the EPMA surface distribution test, the average diameter R of the main phase, the diameter r₁ of the main phase center, the average thickness r₂ of the main phase outer layer and the main phase epitaxial layer were measured. The specific method is as follows:

By combining the system scale in the EPMA surface distribution test results and the “Particle Size Distribution Calculation Version 1.2” software, the average diameter R of the main phase and the average diameter r₁ of the main phase center are measured. The numbers for measurements were 20. Since the grains had irregular shapes, the sizes of the larger and smaller directions of a single grain were measured respectively, and by calculating their average value, the average diameter R of the main phase and the average diameter r₁ of the main phase center can be obtained. The results are shown in Table 1 below.

The average thickness r₂ of the main phase outer layer can be calculated by the average diameter R of the main phase and the average diameter r₁ of the main phase center, specifically: the average thickness r₂ of the main phase outer layer=(the average diameter R of the main phase−the average diameter r₁ of the main phase center)/2. The results of r₂ are shown in Table 1.

According to the EPMA surface distribution test results, the shell thickness of Dy in the Dy surface distribution can be obtained, and the average thickness r₃ of the main phase epitaxial layer can be calculated from it, specifically: The average thickness r₃ of the main phase epitaxial layer=the shell thickness of Dy in the Dy surface distribution/2. The results of r₃ are shown in Table 1.

TABLE 1

| | | | | | Average |
|---|---|---|---|---|---|
| | Average | Average | Average | | Thickness r3 of |
| | Diameter R | Diameter r₁ of | Thickness r₂ of | | Main Phase |
| | of Main | Main Phase | Main Phase | | Epitaxial Layer |
| | Phase (μm) | Center (nm) | Outer Layer (nm) | r₁/r₂ | (nm) |
| Example 1 | 4.7 | 2.9 | 0.8 | 3.62 | 290 |
| Example 2 | 4.5 | 2.0 | 1.2 | 1.67 | 230 |
| Example 3 | 4.6 | 2.2 | 1.2 | 1.83 | 240 |
| Example 4 | 5.2 | 2.5 | 1.4 | 1.78 | 270 |
| Example 5 | 4.5 | 2.5 | 1 | 2.5 | 230 |
| Example 6 | 4.7 | 2 | 1.3 | 1.54 | 210 |
| Example 7 | 5.0 | 2.9 | 1.1 | 2.63 | 240 |
| Example 8 | 5.7 | 3.1 | 1.3 | 2.38 | 220 |
| Example 9 | 4.8 | 2.3 | 1.2 | 1.91 | 210 |
| Example 10 | 5.4 | 3 | 1.2 | 2.5 | 240 |
| Comparative | 4.2 | 3.4 | 0.4 | 8.5 | 230 |
| Example 1 | | | | | |
| Comparative | 5.4 | 4.2 | 0.6 | 7 | 250 |
| Example 2 | | | | | |
| Comparative | 4.6 | 3.6 | 0.5 | 7.2 | 200 |
| Example 3 | | | | | |

### 2. Characterization of Magnetic Properties

The magnetic properties of the magnetic steels containing high-abundance rare earth elements before and after diffusion in Examples 1-2 were tested by using a permanent magnet material testing system NIM-62000. The test results are shown in Table 3 below.

TABLE 2

| | | | | Maximum | |
|---|---|---|---|---|---|
| | | | Coercive | Magnetic Energy | Squareness |
| | | Remanence | Force | Product Bhmax | Hk/Hcj |
| | | Br(kGs) | Hcj(kOe) | (MGoe) | (%) |
| Example 1 | Before Diffusion | 13.52 | 15.61 | 44.78 | 98.6 |
| Example 1 | After Diffusion | 13.38 | 24.85 | 43.56 | 96.2 |
| Example 2 | Before Diffusion | 13.76 | 13.82 | 45.87 | 98.4 |
| Example 2 | After Diffusion | 13.53 | 22.45 | 44.46 | 96.5 |
| Example 3 | Before Diffusion | 13.55 | 16.39 | 44.87 | 97.2 |
| Example 3 | After Diffusion | 13.39 | 24.85 | 43.56 | 96.3 |
| Example 4 | Before Diffusion | 13.46 | 12.57 | 43.32 | 92.4 |
| Example 4 | After Diffusion | 13.26 | 18.62 | 41.76 | 90.8 |
| Example 5 | Before Diffusion | 13.18 | 15.43 | 40.38 | 93.5 |
| Example 5 | After Diffusion | 12.94 | 22.76 | 38.93 | 92.7 |
| Example 6 | Before Diffusion | 13.2 | 11.34 | 41.38 | 95.6 |
| Example 6 | After Diffusion | 13.04 | 18.79 | 39.89 | 93.7 |
| Example 7 | Before Diffusion | 13.39 | 15.45 | 42.55 | 97.8 |
| Example 7 | After Diffusion | 13.25 | 23.81 | 41.69 | 95.4 |
| Example 8 | Before Diffusion | 13.22 | 15.94 | 41.5 | 96.6 |
| Example 8 | After Diffusion | 13.07 | 24.26 | 42.71 | 95.7 |
| Example 9 | Before Diffusion | 13.67 | 9.74 | 29.64 | 84.6 |
| Example 9 | After Diffusion | 13.42 | 16.36 | 38.27 | 85.1 |
| Example 10 | Before Diffusion | 13.36 | 15.45 | 42.55 | 97.8 |
| Example 10 | After Diffusion | 13.21 | 23.81 | 41.59 | 95.4 |
| Comparative | Before Diffusion | 13.52 | 15.61 | 44.78 | 98.6 |
| Example 1 | | | | | |
| Comparative | After Diffusion | 13.29 | 23.46 | 42.36 | 95.3 |
| Example 1 | | | | | |
| Comparative | Before Diffusion | 13.49 | 6.3 | 39.12 | 86.7 |
| Example 2 | | | | | |
| Comparative | After Diffusion | 13.23 | 14.6 | 37.19 | 85.4 |
| Example 2 | | | | | |
| Comparative | Before Diffusion | 13.52 | 15.61 | 44.78 | 98.6 |
| Example 3 | | | | | |
| Comparative | After Diffusion | 13.31 | 19.37 | 40.25 | 80.3 |
| Example 3 | | | | | |

As can be seen from the above tables, the remanence, coercive force, maximum magnetic energy product and squareness of the magnetic steels containing high-abundance rare earth elements obtained in Examples 1-10 are relatively excellent.

In the sintered body raw material composition for the Y-containing magnetic steel in Comparative Example 1, the atomic percentage of Pr (0.22 at %) and the atomic percentage of Nd (0.68 at %) are not within the protection scope of this application. Accordingly, in the microstructure of the magnetic steel obtained in Comparative Example 1, r1/r2 is significantly greater than 5, and the coercive force, maximum magnetic energy product and squareness effect of the magnetic steel are significantly worse than those in Example 1.

In the sintered body raw material composition for the Y-containing magnetic steel in Comparative Example 2, the atomic percentage of Y (0.4 at %), the atomic percentage of Pr (0.18 at %) and the atomic percentage of Nd (0.57 at %) are not within the protection scope of this application. Accordingly, in the microstructure of the magnetic steel obtained in Comparative Example 2, r1/r2 is significantly greater than 5, and the coercive force, maximum magnetic energy product and squareness effect of the magnetic steel are significantly worse than those in Example 1.

In the sintered body raw material composition for the Y-containing magnetic steel in Comparative Example 3, the atomic percentage of Pr (0.22 at %) and the atomic percentage of Nd (0.68 at %) are not within the protection scope of this application. Accordingly, in the microstructure of the magnetic steel obtained in Comparative Example 3, r1/r2 is significantly greater than 5, and the coercive force, maximum magnetic energy product and squareness effect of the magnetic steel are significantly worse than those in Example 1.

1. A preparation method for a magnetic steel containing high-abundance rare earth elements, comprising following steps of:
(1) subjecting a powder of a main alloy and a powder of an auxiliary alloy to mixing, pulverizing, shaping and sintering,
wherein the main alloy has a composition of (REₐPr_{b}Nd_{c})_{d}FeₑAl_{f}Cu_{g}GaₕZrᵢTiⱼBₖ;
RE is a high-abundance rare earth element; RE comprises one or more of La, Ce, Y, Er, Yb, Gd, Tm and Sm;
in terms of atomic percentage, a is 0.05-0.3; b is 0.1-1.2; c is 0.5-0.9; d is 13-15; e is 78-80; f is 0.2-0.4; g is 0.1-0.3; h is 0.2-0.5; i is 0.2-0.4; j is 0.2-0.4; k is 5-6;
wherein the auxiliary alloy has a composition of RₘFeₙCuₒAlₚ;
R is a rare earth element;
in terms of atomic percentage, m is 45-55; n is 35-45; o is 4-8; p is 4-8;
(2) subjecting a sintered body obtained in step (1) and a diffusion source raw material composition to grain boundary diffusion treatment;
wherein, in terms of atomic percentage, the diffusion source raw material composition comprises a heavy rare earth element with a content of more than m.

2. The preparation method for a magnetic steel containing high-abundance rare earth elements according to claim 1, wherein the preparation method for the magnetic steel containing high-abundance rare earth elements satisfies one or more of the following conditions (i)-(vi):
(i) in the composition of the main alloy, RE comprises Y;
(ii) in the composition of the main alloy, in terms of atomic percentage:
a is 0.1;
b is 0.18-1;
c is 0.55-0.8;
d is 13-14;
e is 78.5-80;
f is 0.2-0.3;
g is 0.2;
h is 0.3-0.4;
i is 0.2-0.3;
j is 0.2-0.3;
k is 5.5-6;
(iii) the composition of the main alloy is:
(Y_{0.1}PrNd_{0.9})_{13.64}Fe_{79.26}Al_{0.24}Cu_{0.2}Ga_{0.36}Zr_{0.26}Ti_{0.27}B_{5.75}; or
(Y_{0.05}Pr_{0.18}Nd_{0.57})_{13.64}Fe_{78.88}Al_{0.24}Cu_{0.2}Ga_{0.36}Zr_{0.26}Ti_{0.27}B_{5.75}; or
(La_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or
(Ce_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or
(Yb_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or
(Tm_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or
(Gd_{0.1}Pr_{0.22}Nd_{0.68})_{13.64}Fe_{79.48}Al_{0.24}Cu_{0.2}Ga_{0.36}Zr_{0.26}Ti_{0.27}B_{5.75}; or
(Sm_{0.1}Pr_{0.22}Nd_{0.68})_{13.64}Fe_{79.48}Al_{0.24}Cu_{0.2}Ga_{0.36}Zr_{0.26}Ti_{0.27}B_{5.75};
(iv) in the composition of the auxiliary alloy, R is Dy or Pr;
(v) in the composition of the auxiliary alloy, in terms of atomic percentage: m is 50; n is 40; o is 5; p is 5;
(vi) the auxiliary alloy has a composition of Dy₅₀Fe₄₀Cu₅Al₅ or Pr₅₀Fe₄₀Cu₅Al₅.

3. The preparation method for a magnetic steel containing high-abundance rare earth elements according to claim 1, wherein the preparation method for a magnetic steel containing high-abundance rare earth elements satisfies one or more of the following conditions I-VIII:
I. in step (1), a mass ratio of the powder of the main alloy to the powder of the auxiliary alloy is (90-99):(10-1);
II. in step (1), the pulverizing comprises hydrogen decrepitation pulverization and micro-pulverization;
wherein, the hydrogen decrepitation pulverization comprises hydrogen absorption, dehydrogenation and cooling;
wherein, the micro-pulverization is jet-milling pulverization;
the jet-milling pulverization is carried out in a nitrogen atmosphere having an oxidizing gas with a content of 150 ppm or less;
the jet-milling pulverization is performed at a pulverization chamber pressure of 0.38 MPa;
the jet-milling pulverization is performed for a time of 3 hours;
III. in step (1), the shaping is performed by a magnetic field shaping method or a hot pressing and hot deforming method;
wherein, the magnetic field shaping method is performed at a magnetic field strength of 1.5 T or more;
IV. in step (1), the process of the sintering comprises preheating, sintering and cooling under vacuum conditions;
wherein the preheating is performed at a temperature of 300-600 °C; the preheating is performed for a time of 1-2 h;
wherein, the sintering is performed at a temperature of 1080-1090 °C;
wherein the sintering is performed for a time of 4 h;
V. in step (2), the diffusion source raw material composition is an alloy powder comprising a heavy rare earth element;
wherein, the heavy rare earth element comprises Dy and/or Tb;
the heavy rare earth element has an atomic percentage of 50-80 at %;
VI. in step (2), the diffusion source raw material composition further comprises M; the M comprises one or more of Al, Cu and Ga;
wherein, the M has an atomic percentage of 20-50 at %;
when the M comprises Cu, the Cu has an atomic percentage of 10-25 at %;
when the M comprise Al, the Al has an atomic percentage of 10-25 at %;
VII. in step (2), the diffusion source raw material composition is Dy₇₀Cu₁₅Al₁₅;
VIII. a mass ratio of the sintered body obtained in step (1) to the diffusion source raw material composition is (98-99.5):(0.5-2).

4. The preparation method for a magnetic steel containing high-abundance rare earth elements according to claim 1, wherein the preparation method for a magnetic steel containing high-abundance rare earth elements satisfies one or more of the following conditions IX-XII:
IX. in step (2), the grain boundary diffusion is carried out in a high-purity Ar gas atmosphere; the high-purity Ar gas atmosphere has a pressure of 8×10⁻³ Pa-2×10⁵ Pa;
X. in step (2), the grain boundary diffusion is performed at a temperature of 800-980 °C;
XI. in the grain boundary diffusion, the grain boundary diffusion is performed for a time of 12-30 h;
XII. in step (2), after the grain boundary diffusion, the preparation method further comprises a diffusion heat treatment and/or an aging heat treatment;
wherein, the diffusion heat treatment is performed at a temperature of 850-950 °C; the aging heat treatment is performed for a time of 20-40 h;
wherein, the aging heat treatment is performed at a temperature of 440-580 °C; the aging heat treatment is performed for a time of 2-4 h.

5. The preparation method for a magnetic steel containing high-abundance rare earth elements according to claim 1, wherein the powder of the main alloy is prepared by the following method: subjecting the RE, Pr, Nd, Fe, Al, Cu, Ga, Zr, Ti, and B according to the percentages to mixing, smelting and casting;
wherein the smelting is performed by using a high-frequency vacuum induction smelting furnace; the smelting is performed at a vacuum degree of 5×10⁻² Pa; the smelting is performed at a temperature of 1500 °C or less;
wherein the casting comprises cooling at a rate of 10² °C/sec-10⁴ °C/sec in an Ar gas atmosphere.

6. The preparation method for a magnetic steel containing high-abundance rare earth elements according to claim 1, wherein the powder of the auxiliary alloy is prepared by the following method: subjecting the R, Fe, Cu and Al according to the percentages to mixing, and heating and smelting by using a vacuum induction smelting furnace under the protection of argon at a speed of 10² °C/see to 10⁴ °C/sec.

7. A magnetic steel containing high-abundance rare earth elements, wherein the magnetic steel containing high-abundance rare earth elements is prepared by the preparation method for a magnetic steel containing high-abundance rare earth elements according to claim 1.

8. A magnetic steel containing high-abundance rare earth elements, wherein a main phase of the magnetic steel containing high-abundance rare earth elements comprises a main phase center, a main phase outer layer and a main phase epitaxial layer; the main phase outer layer is located on an outer side of the main phase center and completely covers the main phase center; the main phase epitaxial layer is located on an outer side of the main phase outer layer and completely covers the main phase outer layer;
wherein a content of a high-abundance rare earth element RE₁ in the main phase center is A₁ at %, wherein at % refers to an atomic percentage of the high-abundance rare earth element in the main phase center in the magnetic steel containing high-abundance rare earth elements;
a content of a high-abundance rare earth element RE₂ in the main phase outer layer is A₂ at %, wherein at % refers to an atomic percentage of the high-abundance rare earth element in the main phase outer layer in the magnetic steel containing high-abundance rare earth elements;
A₁ at %>A₂ at %;
wherein the main phase center has an average diameter of r₁, and the main phase outer layer has an average thickness of r₂, 1<r₁/r₂<5;
wherein the main phase epitaxial layer comprises a heavy rare earth element RH; and the main phase epitaxial layer has an average thickness of r₃, 2 nm<r₃<500 nm.

9. The magnetic steel containing high-abundance rare earth elements according to claim 8, wherein the magnetic steel containing high-abundance rare earth elements satisfies one or more of the following conditions \textcircled{1}-\textcircled{10}:
\textcircled{1} the main phase center comprises a light rare earth element RL₁, and the light rare earth element RL₁ comprises the high-abundance rare earth element RE₁;
in the main phase center, the light rare earth element RL₁ comprises Pr and/or Nd; the light rare earth element RL₁ has an atomic percentage of 9.0 at %-10.0 at %;
\textcircled{2} in the main phase center, the high-abundance rare earth element RE₁ has an atomic percentage of 0.5 at %;
\textcircled{3} the main phase outer layer comprises a light rare earth element RL₂, and the light rare earth element RL₂ comprises the high-abundance rare earth element RE₂;
in the main phase outer layer, the light rare earth element RL₂ comprises Pr and/or Nd; the light rare earth element RL₂ has an atomic percentage of 9.0 at %-10.0 at %;
\textcircled{4} the high-abundance rare earth element RE₁ in the main phase center and the high-abundance rare earth element RE₂ in the main phase outer layer independently comprise one or more of La, Ce, Y, Er, Yb, Gd, Tm and Sm;
\textcircled{5} in the main phase outer layer, the high-abundance rare earth element RE₂ has an atomic percentage of 0.5 at %-3.0 at %;
\textcircled{6} the main phase has an average diameter of R, 2 μm<R<15 μm;
the main phase center has an average diameter of r₁, and the main phase outer layer has an average thickness of r₂, and r₁/r₂ is 2-4;
\textcircled{7} the main phase epitaxial layer has an average thickness of r₃, and r₃ is 100-400 nm;
\textcircled{8} in the main phase epitaxial layer, the heavy rare earth element RH comprises Dy and/or Tb;
in the main phase epitaxial layer, the heavy rare earth element RH has a content of 2.5 wt %, wherein the wt % refers to a mass percentage of the heavy rare earth element RH in the magnetic steel containing high-abundance rare earth elements;
\textcircled{9} the magnetic steel containing high-abundance rare earth elements further comprises a grain boundary phase; the grain boundary phase comprises Fe, Al, Cu, Ga, Zr, Ti and B;
\textcircled{10} the anisotropy fields of the main phase epitaxial layer, the main phase center and the main phase outer layer decrease in sequence.

10. Use of a magnetic steel containing high-abundance rare earth elements as an electronic component in an electric motor, wherein the magnetic steel containing high-abundance rare earth elements is as defined in claim 8.

11. The preparation method for a magnetic steel containing high-abundance rare earth elements according to claim 2, wherein the preparation method for the magnetic steel containing high-abundance rare earth elements satisfies conditions (i) to (vi) at the same time.

12. The preparation method for a magnetic steel containing high-abundance rare earth elements according to claim 3, wherein the preparation method for a magnetic steel containing high-abundance rare earth elements satisfies conditions I-VIII at the same time.

13. The preparation method for a magnetic steel containing high-abundance rare earth elements according to claim 4, wherein the preparation method for a magnetic steel containing high-abundance rare earth elements satisfies conditions IX-XII at the same time.

14. The magnetic steel containing high-abundance rare earth elements according to claim 9, wherein the magnetic steel containing high-abundance rare earth elements satisfies conditions \textcircled{1}-\textcircled{10} at the same time.
